(19) United States
(12) Patent Application Publication
(10) Pub. No.: US 2009/0205139 A1
(43) Pub. Date: Aug. 20, 2009

(54) Bed with Lying Support and Method for Dynamically Supporting a Lying Position

(75) Inventors: Dirk Laurens Van Deursen, Voorschoten (NL); Leonardus Laurentius Josph Maria Van Deursen, Bladel (NL)

Correspondence Address: HOFFMANN & BARON, LLP, 6900 JERICHO TURNPIKE, SYOSSET, NY, 11791, US

(73) Assignee: DYNAMIC SLEEPING SYSTEMS INTERNATIONAL HOLDING B.V, WOERDEN (NL)

(21) Appl. No.: 11/883,988

(22) PCT Filed: Feb. 8, 2006
(86) PCT No.: PCT/NL2006/000064

§ 371 Date: Nov. 14, 2008

(30) Foreign Application Priority Data
Feb. 8, 2005 (NL) 1028218

(51) Int. Cl. A61G 7/00; A61G 7/057

(52) U.S. Cl. 5/713; 5/690

(57) ABSTRACT

The invention relates to a lying support such as a bed (2), wherein the lying support (3) comprises movement means for effecting a reciprocal, substantially rotating movement in the back of a person lying on the lying support (3) by imposing a rotation on the intervertebral disks, relative to one another, a mattress and movement means therefor and to a method for supporting a lying person.

The invention relates to a bed.

On average, a healthy person spends about one third of his or her life in a bed, at least lying. For disabled persons such as chronic invalids, this may be even a larger part. This means that lying is one of the most common and most sustained positions. It has been found that a sustained lying position is not beneficial to health. For instance, decubitus symptoms may occur, but also stiffness in, for instance, joints, limbs, the back and the like.

U.S. Pat. No. 4,947,500 describes a mattress for preventing decubitus, by movement in the mattress. U.S. Pat. No. 5,394,577 shows a mattress where lateral rotation of a mattress can be obtained for preventing decubitus. Further, mattresses are described for supporting patients in changing position in or on a mattress. Such systems are, for instance, known from EP 0 913 138 and EP 1 413 280.

The invention contemplates providing a lying support which can offer a good support to a user.

In a first aspect, the invention comprises a lying support such as a bed, while the lying support comprises movement means to effect a reciprocal, substantially rotating movement in the back of a person lying on the lying support. Here, vertebrae are at least rotated relative to one another.

In a second aspect, a lying support according to the invention is characterized in that drive means are provided for moving surfaces on which a part of the user is supported in a lying manner in opposite directions.

In a third aspect, a lying support according to the invention is characterized by means for making a vertebral column of a lying person rotate at a relatively low frequency. Here, relatively low is understood to mean in proportion to, for instance, breathing frequency and heart rate of such a person. The frequency may, for instance, be less than 0.2 Hz.

In a first further elaboration, a lying support according to the invention may be equipped such that it is part of a bed. Alternatively, the lying support may be placeable or receivable on or in a bed, more in particular on or in a mattress. To this end, the mattress may, for instance, be provided with a recess in which the movement means can be placed.

In a further elaboration, the movement means may, for instance, comprise pneumatically driven cushions which can alternately be pumped up more or less for obtaining the desired movements. Such an apparatus is particularly simple and relatively inexpensive.

With a lying support according to the invention, such as a mattress, low back pain (LBP) can effectively be prevented and treated.

The invention further relates to a mattress which is, in a first embodiment, provided with movement means for imposing a reciprocal movement on a lying user.

The invention further relates to movement means for use in a lying support according to the invention.

In a further aspect, the invention relates to a method for imposing a reciprocal movement on a lying person. Such a method can, for instance, improve the general wellbeing of a user, can result in a better saturation and/or can provide a user with better sleep or rest.

By way of illustration, embodiments of the invention will be explained in more detail with reference to the drawing, in which:

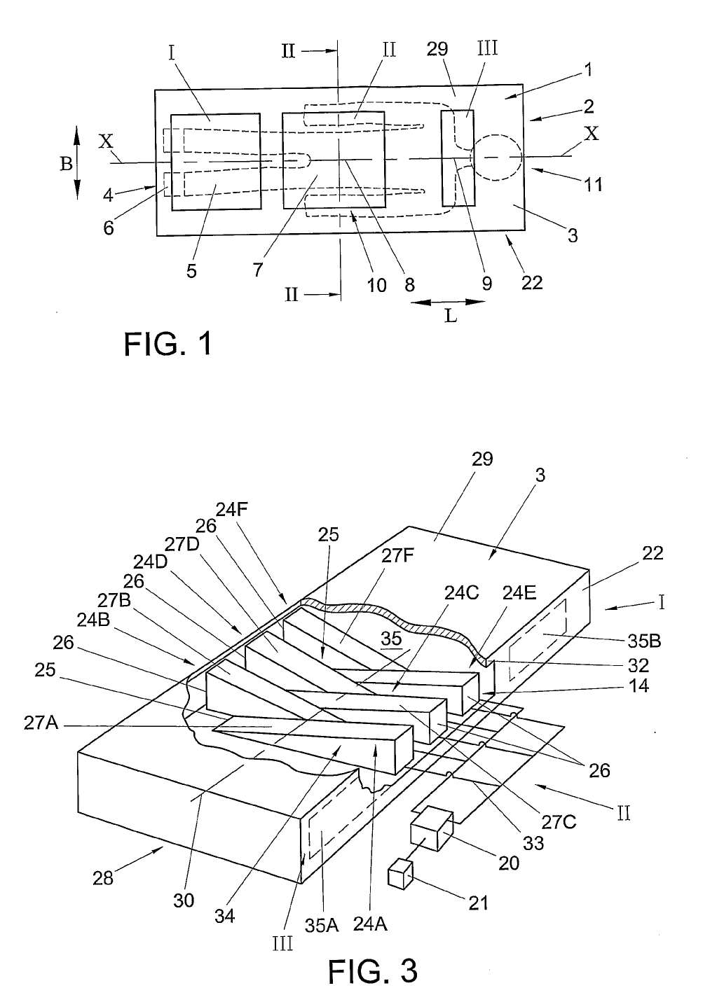

FIG. 1 shows, in top plan view, an embodiment of a lying support according to the invention, in the form of a bed or mattress therefor, with three support zones indicated thereon;

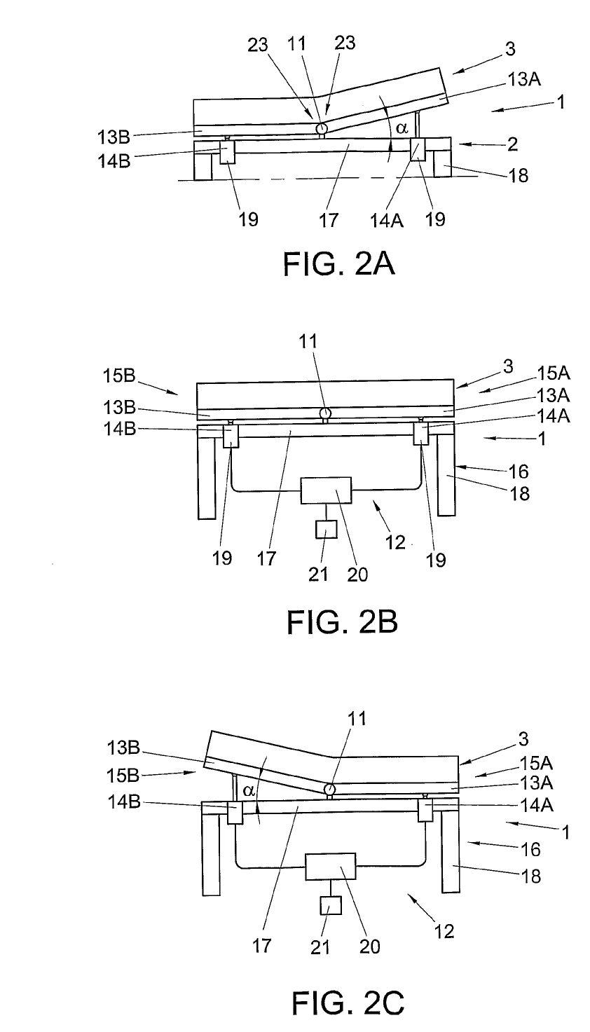

FIGS. 2A-C show, in cross-sectional front view along the line II-II in FIG. 1, the lying support according to FIG. 1;

FIG. 3 shows, in partly cross-sectional view, a mattress as a lying support according to the invention with movement means in a second embodiment;

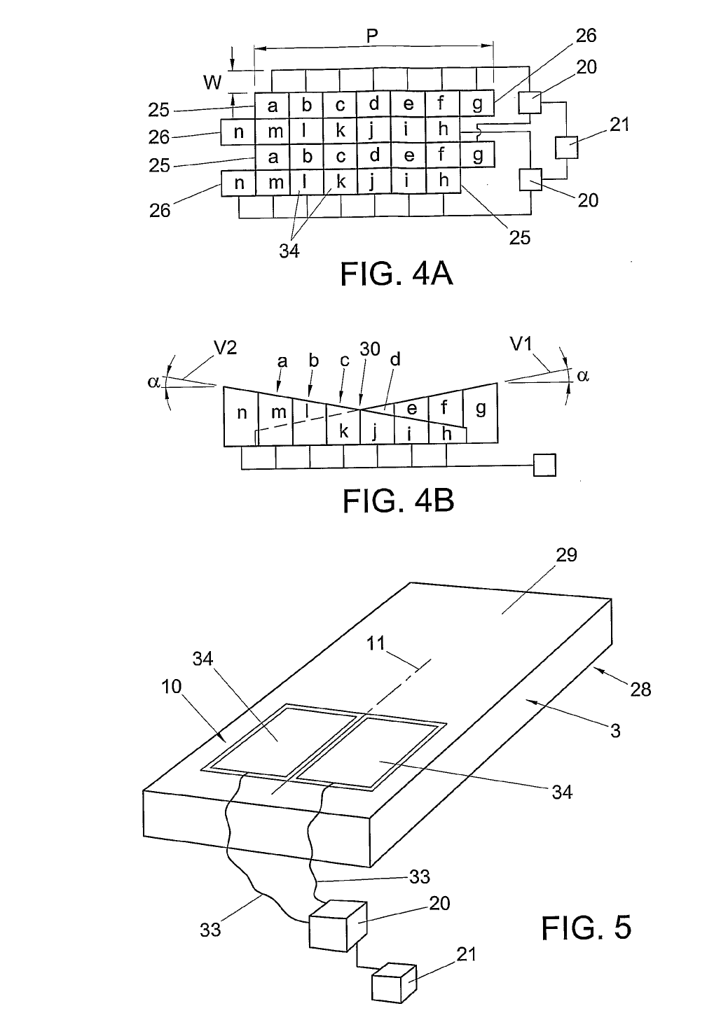

FIG. 4 shows a third embodiment of movement means according to the invention;

FIG. 5 shows a lying support with movement means loosely placed thereon;

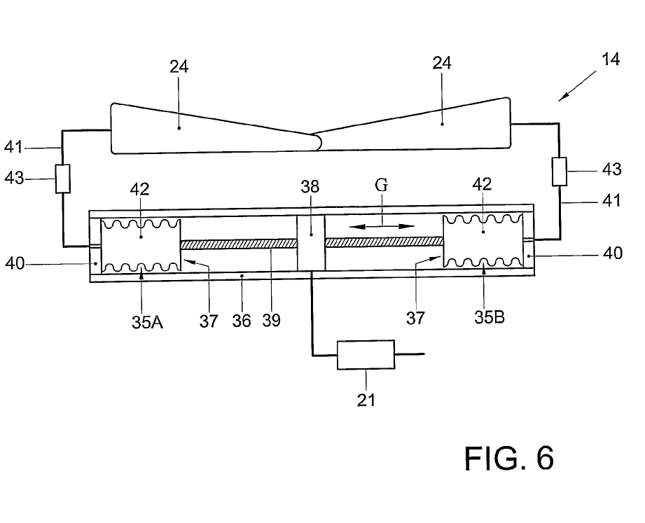

FIG. 6 shows, in partly cross-sectional side view, movement means for an apparatus according to the invention, in an alternative embodiment; and

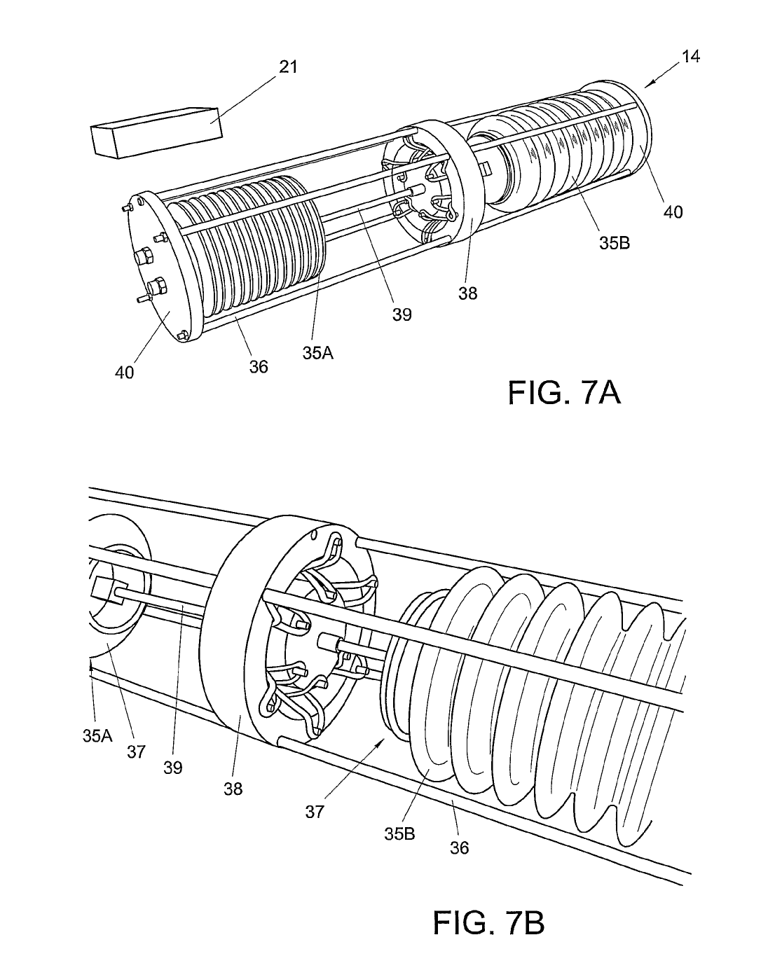

FIGS. 7A and B show, in perspective view, drive means and pressure elements of movement means according to FIG. 6, with FIG. 7B showing an enlargement of a part of FIG. 7A.

In this description, same or corresponding parts have same or corresponding reference numerals. All combinations of (parts of) the exemplary embodiments shown are understood to be included herein. The embodiments shown are only shown by way of illustration and should not be construed as being limitative in any way.

In this description, as a lying support, for instance a bed and a mattress are shown, and combinations thereof. These may have been specially adapted to the invention but it is also possible to use a movement apparatus on or in an existing lying support.

FIG. 1 shows, in top plan view, a lying support 1. In the embodiment shown, this is a bed 2 with a mattress 3 thereon. On the mattress 3, three zones are indicated by rectangles I-III. The first zone I extends over a part on which usually the legs 5 and feet 6 of a user 4 are supported. The second zone II extends over a part where usually at least pelvis 7 and/or lower part 8 of the back of a user 4 are supported. Zone II extends over a part where usually at least the pelvis 7 and/or lower part 8 of the back of a user 4 are supported. Zone III extends Over a part where usually at least the neck 9 of a user 4 is supported. FIG. 1 shows the contour of a user 4 lying on his or her back in broken lines in a stylized manner. It will be clear that the position of the zones I-III can be adjusted depending on the user 4. In each of the zones I-III, movement means 10 as will be discussed hereinafter in more detail can be provided. The movement means 10 serve to impose a reciprocal tilting or rotating movement of at least a part of the body of the user 4, approximately about an axis 11 parallel to the longitudinal direction L of the lying support 1, in particular an axis 11 extending approximately over the centerline X-X of the lying support 1. Thus, on the body of the user, a movement can be imposed which is beneficial to the health and wellbeing of that user. Such a movement may for instance be generated during rest, in particular sleep.

FIG. 2 shows, in cross-sectional view along line II-II in FIG. 1, a lying support 1 with movement means 10 in the form of a movement apparatus 12 therein. In this embodiment, the movement apparatus 12 comprises two pivotal supporting elements 13A, 13B extending on either side of the axis 11. The supporting elements 13, for instance boards, slatted base parts, mesh base parts or the like, are for instance interconnected in or near the axis 11, for instance by hinges. Under each of the supporting elements 13A, B, preferably at a distance from the axis 11, a drive means 14A, 14B has been provided with which the respective supporting element 13A, B can be pivoted relative to the axis 11. To this purpose, an end 15A, 15B of each of the elements 13A, 13B can be brought upwards relative to a bedstead 16 shown here by way of illustration as a frame 17 on legs 18. Of course, the bedstead 16 may be designed in any desired manner.

In the exemplary embodiment shown, the drive means 14A, B each comprise a piston cylinder assembly 19, for instance hydraulically or, preferably, pneumatically drivable by a pump 20. A control unit 21 is provided so that the pump 20, at least the drive means 14A, B are controlled, in a manner to be described hereinafter in more detail. Here, the drive means 14 engage the bottom side of the supporting elements 13A, B, while a mattress 3 is supported on the top side thereof By alternately moving the supporting element 13A located on the right-hand side of the axis 11 (FIG. 2A) and the supporting element 13B located on the left-hand side thereof (FIG. 2C) upwards while the other one is moved or has been brought downwards, each time a side of the body 4 is somewhat lifted up locally while the other side is brought down again locally. This creates a reciprocal tilting and/or rotating movement in the respective part of the body.

The supporting elements 13A, 13B are pivoted through an angle α, preferably from a horizontal position upwards. In the drawing, the angle α is shown in a somewhat overlarge manner, by way of clarification. In practice, the angle α is preferably less than 5°, preferably less than 3°, more in particular less than 2° or for instance about 1° or less, such as about 0.5°. By means of the control unit 21, the frequency at which the supporting elements 13A, 13B are moved upwards and downwards is set. The setting is preferably chosen such that a pivotal movement and/or rotation in the respective part of the body is obtained at a relatively low frequency, for instance less than 1 Hz, more in particular less than 0.2 Hz and preferably for instance less than one movement per minute (<0.016 Hz) or intermittently. In a first embodiment, the frequency has been preset and cannot be controlled by the user. In a second embodiment, this frequency is settable for the user, preferably within preset limit values. In a third embodiment, a number of frequencies have been set which a user can choose from. Frequencies may, for instance, be chosen depending on the zone I-III in which the movement means have been provided, weight, age, sex and the like of a user or personal preferences. Also, on the basis thereof, the control unit may control, for instance, the pressure, at least the upward force, in the movement means, in order to obtain the desired frequency independently of the user.

A low to very low frequency and small amplitude of imposed, lateral movement, in particular rotation, in, for instance, the low back (lumbar) or in the neck area (cervical) has been found particularly advantageous for preventing and controlling pain. Here, different parts of the vertebral column are moved in different directions relative to one another so that at least some rotation in the vertebral column is effected, preferably at different intervertebral disks. Through suitable control, preferably by means of a choice from different preprogrammed programs, different movement patterns can be imposed.

Viewed in the longitudinal direction L, the movement apparatus 12 preferably has a dimension which is considerably smaller than the length of the lying support 1 itself. This dimension is, for instance, approximately equal to the length of the respective zone I-III. Because the angle α is relatively small, the mattress 2 will bend at the height of the moving supporting elements 13A, 13B as shown in FIGS. 2A and C, while, viewed in the longitudinal direction, the mattress will remain virtually flat in front of and behind these elements 13.

In the embodiment shown, two supporting elements 13A, 13B are shown which are interconnected in an axis 11. However, of course, multiple supporting elements 13 may also be provided, or the proximal longitudinal edges 23 can be located at a distance from each other. These may each, for instance, be connected with an axis similar to axis 11, which axes 11 are located at a mutual distance from each other, viewed in width direction B of the lying support, approximately parallel to each other. Here, the pivotal axis 11 for the left supporting element 13B may be located on the left-hand side and the pivotal axis for the right supporting element 13A on the right-hand side of the centerline X-X. However, preferably, the pivotal axis 11 for the right supporting element 13A is located on the left-hand side and the pivotal axis for the left supporting element 13B on the right-hand side of the centerline X-X. Here, the proximal longitudinal edges 23 are forked so that they can engage. Thus, a gradual transition in the movements is obtained. This is because the intersecting line between the two supporting elements will shift with the movement of the two supporting elements 13. In this respect, this solution is similar to the solution according to FIGS. 3-4.

It will be clear that the movement means 14 may also have a different design, for instance electrically driven. To this end, instead of the piston cylinder assemblies, use may, for instance, be made of electrically driven screw spindles. Also, the supporting elements may be interconnected such that they can be pivoted jointly, in a fixed relative position or such that the relative position changes with the joint movements of the two supporting elements 13A, 13B.

FIG. 3 shows, in a partly cutaway view, a mattress 3 with movement means 13 therein in the form of a movement apparatus 14 with a series of cushions 24 arranged next to one another, viewed in the longitudinal direction L. In the embodiment shown, six cushions 24A-F are provided. Each cushion 24 has a substantially triangular shape, viewed in side elevation, while the cushions 24A-F have been placed alternately such that, each time, a low side 25 is approximately next to at least one high side 26 of an adjacent cushion. In the embodiment shown, the cushions 24 each have an equal width W, viewed in the longitudinal direction L of the mattress 3, and a length P, viewed in the direction B which is somewhat smaller than or approximately equal to the width of the mattress. The high sides 26 are closer to the longitudinal sides 22 of the mattress 3 than the low sides 25. The cushions 24 are preferably substantially equal to one another.

Each cushion has a top surface 27A-F, while the top surfaces 27A, C and E of the cushions 24A, C, E are located in a first surface V1 and the top surfaces 27B, D and F of the other cushions in a second surface V2. In FIG. 3, each of the surfaces V1, V2 is inclined at an angle α with respect to the top surface or bottom surface 28, 29 of the mattress. The surfaces V1, V2 thus include an angle of 180°-2α. This is a “central position” of the two surfaces. Here, an intersecting line 30 is determined which is approximately parallel to, and in this position right over, the centerline X-X of the mattress 3. The cushions 24 are all connected to a device 20 for supplying and discharging air or another fluid into and out of the cushions, which is controlled by a control unit 21. The device 20 is, for instance, a pump.

In the example shown, each cushion 24 contains one chamber 34 which can be filled with a fluid, in the example shown air. As a result, the respective cushion 24 will increasingly assume the shape shown in FIG. 3 and thus move a mattress part 32 resting thereon upwards, away from the bottom surface 28. At least the weight of a user 4 and of the mattress part 32 will thus deform the mattress part to a very flat V-shape, optionally tilted. By draining or pumping the fluid off from the chamber, the weight of the user 4 and/or of the mattress part 32 will increasingly flatten the respective cushion 24, so that the respective part of the mattress part supported on or by the respective cushion 24 will move downwards. By now controlling the pump device 20 with the aid of the control device 21 such that, alternately, the first row of cushions 24A, C, E is pumped up and simultaneously the second row of cushions 24B, D, F is pumped out and vice versa, alternately, the one side of the mattress part 32 and the other side thereof will be moved upwards while the other part moves downwards. This causes a reciprocal movement imposed on a part of the body of a user 4 located on the respective mattress part. This may again take place at a relatively low frequency and amplitude, for instance less than 1 Hz and an angle smaller than 3°.

It will be clear that the cushions 24A, C and E can also be intercoupled, such that they can jointly be pumped up and emptied. The same holds for the other cushions. Also, the pump means may be designed such that the fluid which is pumped from the one row of cushions is pumped into the other row of cushions and/or that buffers outside of the cushions are used in which fluid can be buffered temporarily when it is pumped off from the cushions. The control unit may be designed such that always the same amount of fluid is pumped into the cushions. However, control may also take place in a pressure-controlled manner, with the amount of fluid which is pumped into the cushions always depending on the pressure sustained by the cushion, for instance because of a user. Thus, the amplitude can continuously be adjusted or, conversely, be kept equal all the time, irrespective of the load. To this end, for instance a pressure gauge may be included in the cushions and/or the device 20.

It will be clear that the cushions do not always need to be filled completely. If a smaller amplitude is desired, it can be decided to fill the cushions less. By means of the speed of pumping the medium into and off from the cushions, the frequency of the imposed reciprocal movement can be controlled. In addition, this speed can be varied during filling of the cushions or, conversely, emptying them, in order to control the movements of the user still further.

FIGS. 4A and B show, in top plan view and side elevational view, respectively, an alternative embodiment of a movement apparatus 14, similar to the one according to FIG. 3. However, here, each of the cushions 24 (four of which are shown) is divided into separate chambers 34a-g and 34h-n, respectively. In this embodiment, a supply and discharge line 33 of the pump device 20 opens into each of these chambers 34a-g and 34h-n, respectively. In the embodiment shown, one line is connected with each of the chamber 34 of one cushion, but, also, each chamber 34 may be provided with an individual supply and discharge line. By a suitable choice of the flow rate of the supply lines to the chambers 34, it can be controlled in what order the chambers are pumped up and/or pumped out, so that the movement of the top surfaces V1, V2 can be controlled accurately. When individual lines to the different chambers are used, this can simply be controlled by use of one or more suitable valves between the pump device 20 and each of those lines. Incidentally, of course, flow rate limiters and/or valves may be provided near the chambers 34. It will be clear that, upon movement of the surfaces V1, V2 relative to each other, the intersecting line 30 will shift laterally. This effect can be counteracted or, conversely, enhanced by filling and/or emptying the chambers of the cushions more quickly in a suitable manner. Shifting of the intersecting line may provide a larger, more complicated movement for the user, which may be periodically advantageous.

It again holds for this embodiment that cushions, in particular chambers, can be intercoupled and that fluid can be pumped from one chamber into another or into a buffer and vice versa. Of course, in these embodiments, the cushions may also have a different shape than completely triangular, for instance with a concave or an angular top surface V.

In the embodiment shown in FIG. 4, the movement apparatus 10 is included in a recess 35 in the mattress 3. To this end, the mattress may have been formed around the movement apparatus 10, for instance by foaming, so that the apparatus 10 forms an integral whole therewith. The apparatus may also have been provided in the mattress 3 later, in a premanufactured recess. In the embodiment shown, the mattress 3 is provided with an opening which is open at least to one side surface and preferably both side surfaces. The apparatus 10 is, can be or can have been slid into the recess 35. The control unit and pump means preferably remain outside the mattress 3. In the embodiment shown, the recess 35 is provided in the second zone II (FIG. 1), for movement of the pelvis and back region of a user. Near the head (third zone III) and/or near the foot (first zone I), similar recesses may be provided. In the exemplary embodiment shown, these recesses 35A, 35B have been filled with, for instance, foam rubber, latex, natural rubber or a different mattress part, which part can be taken out if a movement apparatus 10 is to be placed in the respective recess. In a similar manner, such a mattress part can be introduced into the recess 35 in the mattress if the movement apparatus is removed. It will be clear that, in a similar manner, any mattress 3 can be made suitable for such a movement apparatus. A mattress with at least one such recess is explicitly considered to be described separately as well, and also in combination with the filling mattress parts.

FIG. 5 shows a further alternative embodiment of the invention, where a movement apparatus 10 has been laid on a mattress 3, on the top surface thereof. In this embodiment, the movement apparatus 10 comprises two chambers 34, on either side of a centerline. Pump means 20 with a control device 21 are again provided for alternately pumping up and pumping out the chambers 34, so that again a reciprocal movement can be imposed on a part of the body of a user resting on the apparatus. An advantage of such an apparatus is that it has a simple construction and use and can be deployed in any position on the mattress. Of course, each chamber may again have a somewhat triangular or trapezoid shape so that outer parts are pumped up higher than parts located closer to the centerline. An apparatus 10 as shown herein may also be constructed as shown in FIG. 3 or 4 and may be loosely placeable on the mattress and/or attachable thereto with, for instance, bands, Velcro or similar suitable means immediately apparent to a skilled person.

FIGS. 6 and 7A, B show an alternative embodiment of movement means according to the invention, in particular drive means 14 therefor. Incidentally, these can also be used outside of the invention. In this embodiment, two pressure elements in the form of bellows 35 are provided, mounted at a distance from each other in a frame 36. Between the proximal ends 37 of the bellows 35, a motor 38 has been provided, in particular an electric motor. A stepping motor is advantageous, because can control can take place simply and accurately therewith, with little noise and little energy. Through the motor 38, a screw spindle 39 extends whose opposite ends are connected with the above-mentioned ends 37 of the bellows. With the aid of the motor 38, the screw spindle 39 can be moved back and forth in the direction G (FIG. 6) so that alternately the one bellows 35A is pressed against an end plate 40 of the frame 36 and the opposite bellows 35B is drawn out or the other way round. Each of the bellows 35A, B is in connection with a cushion 24 via a line 41 as, for instance, shown in the foregoing Figures, and forms a chamber 42 filled with a fluid, in particular air. By compression of the respective bellows 35A, B, this air can be pressed through the line 41 into the respective cushion 24, for at least partly inflating it, or can be suctioned out of the above-mentioned cushion 24 by drawing out the bellows 35A, B, or can be pressed out of the cushion 24 upon loading of the cushion, into the chamber 42 in the respective bellows 35A, B.

In use, the motor 38 is preferably driven reciprocally, such that alternately the one bellows 35A and the other bellows 35B is compressed while the other is drawn out. Thus, alternately the two cushions or series of cushions 24 on either side of the centerline are inflated. This drive unit offers the advantage that the motor is relatively quiet, so that a user on the bed is not hindered thereby. Because, each time, a bellows 35A, B forms a closed system with line 41 and connected cushion or series of cushions, the advantage is achieved that no air escapes or is suctioned in to or from the environment, so that the system is still quieter. Further, with relatively little energy, the desired control can be obtained, while the motor 38 can control this accurately. In the lines 41, automatic pressure regulating valves 43 may have been provided, so that always the desired amount of air is maintained in the systems. Incidentally, it will be clear that a same type of system may be provided in which, instead of air, a different medium is used, for instance water, oil or a different gas. In addition, the pressure elements may be designed differently from bellows, for instance as piston cylinder assemblies. Also, a different type of motor may be provided, for instance a linear motor, or other drive means may be used, for instance a hydraulic or pneumatic motor. Alternatively, two or more pumps working in opposite directions which can suction and blow may be connected to the lines 41.

With an apparatus according to the invention, and in particular with a drive unit according to FIGS. 6 and 7, preferably a control unit 21 is provided, equipped with an electronic circuit and programming options. Preferably, a series of programs has been preprogrammed therein, for instance for operatively controlling the motor according to different protocols, so that, for instance, speed, intervals, amplitudes, angles of inclination, frequency and the like can be controlled, individually or in combination.

It has been found that an apparatus according to the present invention, at least a reciprocal movement of one or more parts of the body, in particular the vertebral column, more in particular the lower back and neck and the legs, generated in the body of a user supported by a lying support at an above-mentioned relatively low frequency is particularly beneficial to the general wellbeing of the user and rest is not disturbed thereby but rather improved. Thus, a better saturation appears to be effected of different parts of the body, including the extremities and the back and/or neck, and the saturation of the skin and muscular tissues appears to be influenced positively. In addition, stress-related symptoms appear to decrease in users. Herein, a reciprocal movement is at least understood to mean a movement going back and forth, rotating or as a combination of rotation and translation, with respect to a longitudinal direction of the body of the user and/or of the lying support, irrespective of whether the amplitude and the frequency are constant or vary in time.

The invention is by no means limited to the exemplary embodiments shown and described in the description and the drawing. Many variations thereof are possible within the framework of the invention as set forth in the claims.

Thus, multiple movement means located next to one another and/or at a distance from one another may be provided in one lying support, which, for instance, initiate the same or oppositely directed movements. All embodiments shown may be combined, as a whole or parts thereof, while the fields of application and manners of placement can be used for all embodiments. Combinations and variations thereof will be immediately apparent to a skilled person.

1. A lying support such as a bed, wherein the lying support comprises movement means for effecting a reciprocal, substantially rotating movement in the back of a person lying on the lying support by imposing a rotation on intervertebral disks, relative to one another.

2. A lying support according to claim 1, wherein the movement means comprise at least two abutting surfaces located at a distance from one another, wherein drive means are provided for moving the abutting surfaces up and down in opposite directions.

3. A lying support according to claim 1, wherein the movement means comprise a series of movement elements, provided at a mutual distance from one another, in series viewed along a line in a longitudinal direction of the lying support.

4. A lying support according to claim 1, wherein at least one movement element of the movement means has been placed in a lower back-supporting part of the lying support.

5. A lying support according to claim 1, wherein at least one movement element of the movement means has been placed in a neck-supporting part of the lying support.

6. A lying support according to claim 1, wherein the movement means are designed for initiating said rotating movement at a frequency which is relatively low, in particular less than about 0.2 Hz.

7. A lying support according to claim 1, wherein the movement means are designed for initiating said rotating movement through an angle of less than 2 degrees, more in particular less than 1 degree, for instance about half a degree.

8. A lying support according to claim 1, wherein the movement means are included in a mattress of the lying support.

9. A lying support according to claim 1, wherein the movement means are included in a mattress support.

10. A lying support according to claim 1, wherein the movement means are placed on a mattress.

11. A lying support according to claim 1, wherein the movement means comprise pneumatic cushions, and pump means for periodically pumping gas, in particular air, into the pneumatic cushions.

12. A lying support according to claim 11, wherein at least two somewhat triangular cushions are provided, which are inclined in opposite directions from a low end located near a centerline of the lying support to a high end located near a longitudinal side of the lying support.

13. A lying support according to claim 1, wherein a mattress is provided which comprises a recess in which the movement means are at least partly placeable or are included.

14. A lying support according to claim 1, wherein the movement means comprise a drive unit, which comprises at least two pressure elements located at a distance from one another, which are reciprocally drivable with the aid of a drive unit, wherein the pressure elements each comprise a chamber and are designed for displacing a fluid from said chamber to at least one fluid chamber of the movement means or receiving said fluid from said chamber, for alternately at least partly pumping up and pumping out the cushions.

15. A lying support according to claim 14, wherein the pressure elements comprise bellows which form said chambers and which are movable between an at least partly compressed position with a relatively small content and an at least partly drawn-out position with a relatively large content with the aid of the drive unit.

16. A lying support according to claim 14, wherein the drive unit comprises an electric motor, in particular a stepping motor, wherein, preferably, a spindle is provided for transmitting movements from the motor to the pressure elements.

17. A mattress, provided with movement means for effecting a reciprocal, rotating movement in the back of a person lying on a lying support by imposing a rotation on intervertebral disks, relative to one another.

18. A mattress according to claim 17, wherein the mattress is, on at least one side, provided with a recess extending under a lying surface of the mattress to at least beyond a centerline of the mattress, which centerline extends substantially at right angles to the said side.

19. Movement means for placement in or on a lying support, in particular in or on a mattress, which movement means comprise, on two sides of a center, an element movable in a direction approximately at right angles to a main surface.

20. Movement means according to claim 19, wherein said elements comprise cushions and wherein drive means are provided, which comprise a motor and two pressure elements, in particular bellows, for alternately introducing and removing fluid from said cushions, alternately on two opposite sides of a center.

21. A movement apparatus according to claim 20, wherein said motor is an electric motor, in particular a stepping motor.

22. A method for supporting a lying person, wherein movement means are provided under a part of the body at least partly comprising the vertebral column, which movement means are brought upwards alternately on a first side and a second side of the respective part of the body, such that a reciprocal, rotating movement of and/or in the respective part of the body is obtained, in particular in and/or near said vertebral column.
